(19) United States
(12) Patent Application Publication
(10) Pub. No.: US 2007/0027677 A1
(43) Pub. Date: Feb. 1, 2007

(54) METHOD OF IMPLEMENTATION OF AUDIO CODEC

(76) Inventors: He Ouyang, Shanghai (CN); Binghui Wu, Shanghai (CN); Yi Zhou, Shanghai (CN); Lin Luo, Shanghai (CN); Kai Wan, Shanghai (CN)

Correspondence Address: SINORICA, LLC, 13604 VALLEY OAK CIRCLE, ROCKVILLE, MD, 20850, US

(21) Appl. No.: 11/458,143

(22) Filed: Jul. 18, 2006

(30) Foreign Application Priority Data
Jul. 29, 2005 (CN) 200510028302.0

(51) Int. Cl. G10L 19/00

(52) U.S. Cl. 704/200.1

(57) ABSTRACT

This invention discloses an implementation of audio codec, which has low computational complexity, small memory footprint and high coding efficiency. It can be used in handheld devices, SoC or ASIC products and embedded systems. At the encoder side: first, apply time-to-frequency transform to audio signals, obtaining un-quantized spectrum data; second, based on the un-quantized spectrum data and target bit count, calculate the corresponding information of optimal scale factor, frequency band group, code table index and quantized spectrum by iteration; third, calculate and format bit-stream; fourth, output formatted bit-stream. At the decoder side: parse the formatted bit-stream, apply decoding and inverse quantization to the spectrum of each frame, reconstruct temporal audio data by frequency-to-time transform, and reconstruct the time-domain signals of each channel.

### FIELD OF THE INVENTION

The present invention relates generally a method of audio coding, which can be applied in handheld devices, SoC or ASIC products and embedded systems, especially an implementation of low-complexity high-quality wideband audio codec.

### BACKGROUND OF THE INVENTION

Among the current audio coding technologies, most of wideband audio compression implementations are built based on frequency band partition and make use of human psychoacoustic model. In the process of the spectrum analysis with the psychoacoustic model, the so-called redundant information is removed by utilizing masking effect of human ears, consequently, the signals in some certain frequency bands, which are considered to be undetectable by human ears, are removed. The benefit of doing so is more “important” frequency component can be represented with more data bits. However, the drawback is also obvious. Firstly, the computational complexity is significantly augmented to implement audio coding based on the psychoacoustic model; secondly, it is inevitable to store additional constants to characterize the model in the audio codec, and the number of model constants is considerably large, for example, the number of model constants in MPEG-1 Layer 3 (MP3) is more than 4,700. It will increase the fixed data storage significantly. In addition, the decoded audio signal sounds raucous especially under low bitrate cases, which significantly impair the audio quality. Besides, some audio codecs (e.g. WMA) is probable to reduce the audio fidelity and harm the audio quality by means of noise shaping which spreads quantized noise into the corresponding spectrum coefficients.

### SUMMARY OF THE INVENTION

The present invention seeks to provide a method of implementation of audio codec with low computational complexity, small memory footprint and high coding efficiency.

To address the above technical problems, the present invention discloses a method of implementation of audio codec: at the encoder side, step 1, apply time-to-frequency transform to audio signals, obtaining un-quantized spectrum data; step 2, based on the un-quantized spectrum data and targeted bit count, calculate the corresponding information of optimal scale factor, frequency band group, code table index and quantized spectrum by iteration; step 3, calculate and format bit-stream; step 4, output formatted bit-stream; at the decoder side, parse the formatted bit-stream, apply decoding and inverse quantization to the spectrum of each frame, reconstruct temporal audio data by frequency-to-time transform, and reconstruct the time-domain signals of each channel.

The above said step 2 further comprises: first, count the total coded bit based on the quantized spectrum data; next, compare it with the expected bit count. If it can not meet the expectation, adjust scale factor and change the information of each scale factor, consequently, quantized spectrum data is changed and the information of frequency band group and the relevant coding tables are adjusted accordingly; recalculate the total coded bit count and iterate until it is converge to the expected bit count, and obtain the formatted bit-stream.

In addition, the quantization of spectrum is applied based on Bark band (critical frequency band); the same scale factor is used in all the frequency sub-bands of the same frequency band, and the scaling step-size is (\sqrt{2})^{-Scalefactor}.

In addition, each frequency band group is composed of the neighboring class-A and class-B frequency band.

In addition, one of the four class-A coding tables is used for the coding of class-A frequency bands, and the same coding table is used for the same frequency band.

In addition, one of the 22 class-B coding tables is used for the coding of class-B frequency bands, and the same coding table is used for the same frequency band. In comparison with conventional wideband audio codec, such as MPEG-1 Layer 3 (MP3), AC-3 and WMA etc., the present invention does not rely on the psychoacoustic model of human ears, nor does it artificially eliminate any frequency component below the cut-off frequency and add man-made noise. It makes the transform of time-to-frequency or frequency-to-time only once at the side of encoder or decoder. The present invention makes the computational complexity be greatly reduced to about ⅕ of that of conventional wideband audio codec. The quality loss caused by compression is minimized and the integrity of frequency components is maximally preserved because no frequency component below the cut-off frequency is artificially removed, no man-made noise is introduced and a more efficient coding strategy based on frequency band groups is employed. This invention also features the sufficient dynamic range and sound orientation, which makes human ears easy to discern and position sound sources and distinguish small differences between high frequency components and low counterparts, as a result, the very high decoded audio quality is guaranteed. Besides, the constants to be stored for this codec is significantly reduced due to the very limited number of coding tables, while the total entries and psychoacoustic model constants of MPEG-1 Layer 3 (MP3) exceeds 1,410 and 4,700 respectively.

### BRIEF DESCRIPTION OF THE DRAWINGS

FIG. 1 is the flow chart of the encoder;

FIG. 2 is the flow chart of the decoder;

FIG. 3 represents the bandwidth distribution of each Bark band;

FIG. 4 represents the partition of frequency band groups;

FIG. 5 illustrates the binary-tree of the coding tables for class-A frequency bands;

FIG. 6 illustrates the binary-tree of the coding tables for class-B frequency bands;

FIG. 7 shows one partition example of the frequency band groups.

### DETAILED DESCRIPTION OF EMBODIMENTS

The present invention is further explained by the combination of attached figures and detailed implementation description.

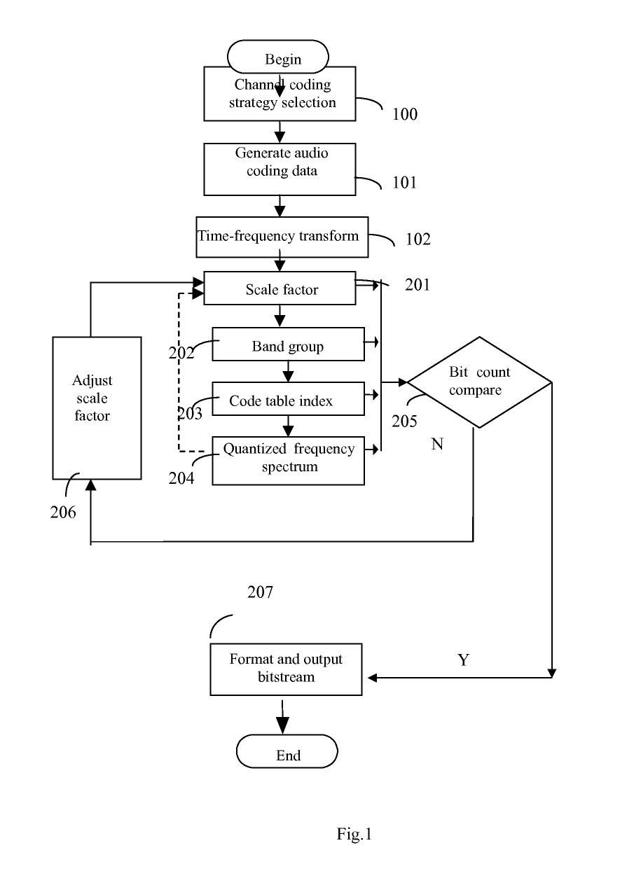

FIG. 1 is the flow chart of the encoder. The encoding procedure is as below:

First, perform the windowing to audio signals, extract the frame and make time-to-frequency transform, and convert the signals into frequency domain; the module 100, which determines the channel coding mode, selects either the stereo coding mode or dual-channel independent coding mode based on whether the input audio signal is indicated to stereo or the correlation estimation of the left and right channel; the flow goes to module 101, which generates the audio data to be coded, after channel coding mode is determined; it computes the expected bit count for the current frame, then one frame of audio data is imported (512 samples per channel) to compose a processing frame (1,024 sample per channel) with the previous frame in the same channel. The processing frame multiplies the sine window function; at last, the windowed 1024 audio data are passed to module 102 to perform time-to-frequency transform, obtaining the un-quantized spectrum.

Second, perform quantization on the un-quantized spectrum. Iterative method is used to retrieve the optimal information of scale factor (module 201), frequency band group (Module 202), coding table index (module 203) and quantized spectrum (module 204) based upon the un-quantized spectrum and target bit count; finally, the total coding bit count is computed.

Third, the total coding bit count is compared with expected bit count in Module 205; if the expectation is not satisfied, the scale factor will be adjusted accordingly in module 206 and repeat the second step until the expected bit count is achieved.

Lastly, the bit-stream is formatted and outputted by Module 207.

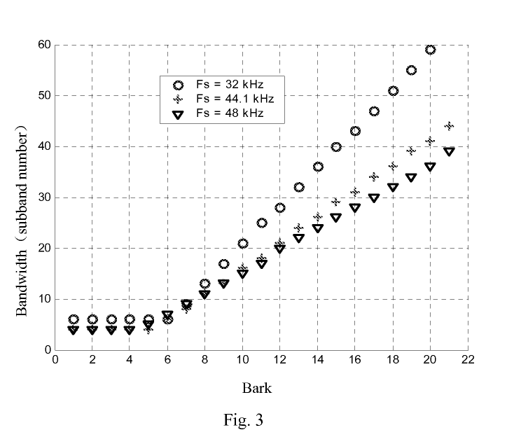

Module 201 aforementioned quantizes the spectrum according to the scale factor of each Bark frequency band. The initial scale factors may be arbitrary. Choice of scale factors is the key to quantize the spectrum which has direct impact on the coded audio quality and the size of coded bit-stream. The quantization of spectrum adopts the strategy based on the partition of Bark frequency bands, that is, different scale factors are used for different Bark bands and all the frequency sub-bands in one Bark band use the identical scale factor. Partition of frequency band is related with the sampling rate of audio signals. FIG. 3 illustrates the bandwidth distribution of each Bark frequency band (Unit: Bark number) at the sampling rate of 32 KHz, 44.1 KHz and 48 KHz. The quantization of spectrum makes use of the method with the step-size of (\sqrt{2})^{-Scalefactor}, in which Scalefactor is the quantization factor, an integer in [−31, 31]. The scale factor is encoded into the coded bit-stream with offset and differential coding. It can be seen that this invention does not need to store the quantization coding table, and it is advantageous to reduce the storage requirement for the codec.

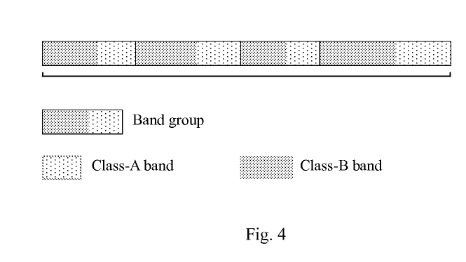

Module 202 aforementioned makes the band group partition for the frequency bands below the cut-off frequency according to quantized spectrum. This strategy is one of the significant differences with other wideband codec, and it is the foundation to improve the coding efficiency further. An example of band group partition is given in FIG. 4, and following six points shall be followed:

1, At most 4 frequency band groups are allowed. They may be less than 4, but at least one;

2, Each frequency band group is composed of neighboring class-A and class-B frequency bands;

3, In class-A frequency bands, the maximum absolute value in all the frequency sub-bands is 1, that is, the quantized value of each frequency sub-band in class-A frequency bands is one of the set {+1, 0, −1};

4, In class-B frequency bands, the maximum absolute value in all the frequency sub-bands is above 1, but frequency sub-bands with absolute value less than or equal to 1 may be included in class-B frequency bands;

5, As a special case, if the maximum absolute value of all the frequency sub-bands is 1, the maximum absolute value of frequency sub-bands in class-B frequency bands may be 1 in order to achieve less coded bits.

6, As a special case, class-A or class-B frequency bands in one frequency band group may be vacant. If one type of frequency bands is vacant, accordingly, the encoding/coding of the relevant spectrum is skipped.

The partition of frequency band groups will affect the size of coded bit-stream. The ultimate principle is that the better partition makes the less coded bits. The final information on frequency band partition (the boundary information of each class-A and class-B frequency band) is coded into the bit-stream.

The present invention adopts two different kinds of coding method for class-A and class-B frequency bands respectively. The coding is only applied to non-sign parts, and sign parts are coded with 0/1.

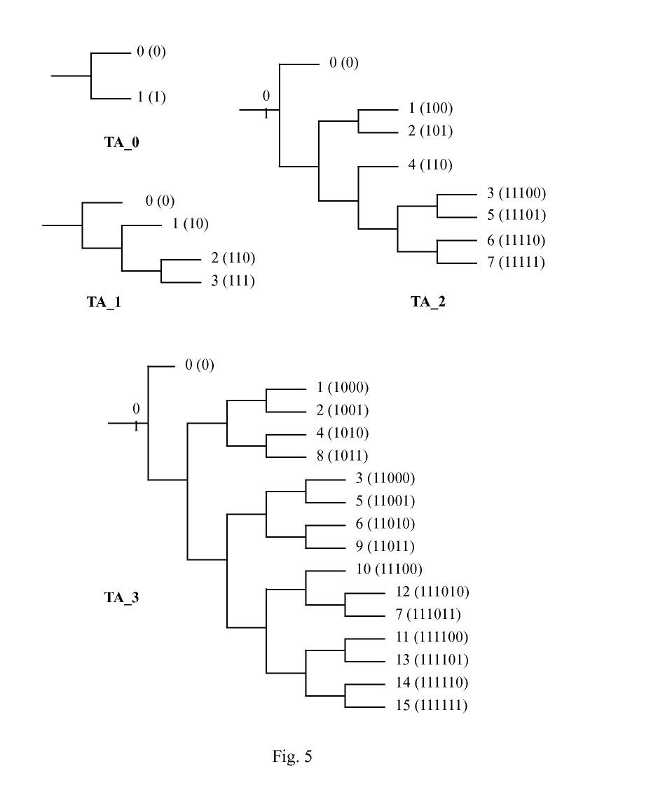

Class-A frequency bands are coded with one of the 4 class-A coding tables, and the same frequency band uses the same coding table. FIG. 5 gives the binary-tree representation for all the four class-A coding tables. TA_{—}0 table corresponds to 0/1 coding. TA_{—}1, TA_{—}2 and TA_{—}3 correspond to coding tables for frequency bands with 2, 3 and 4 frequency sub-bands respectively. Take TA_{—}2 as example, codeword “110” corresponds to 4, and the 3-bit binary represent for 4 in reserve order is “001”. The “001” represents the absolute value of frequency spectrum of the neighboring 3 frequency sub-bands respectively. It shows statistically (including all kinds of music, high, medium and low human voice etc.) that in order to achieve the less coded bits, under 50% cases, the coding system will use TA_{—}1, TA_{—}2 or TA_{—}3 instead of 0/1 coding. The coding method for class-A frequency bands in this invention can effectively reduce coded bits and improve the coding efficiency. The saved bits account for above 15% (class-A frequency band coding) according to the incomplete statistics.

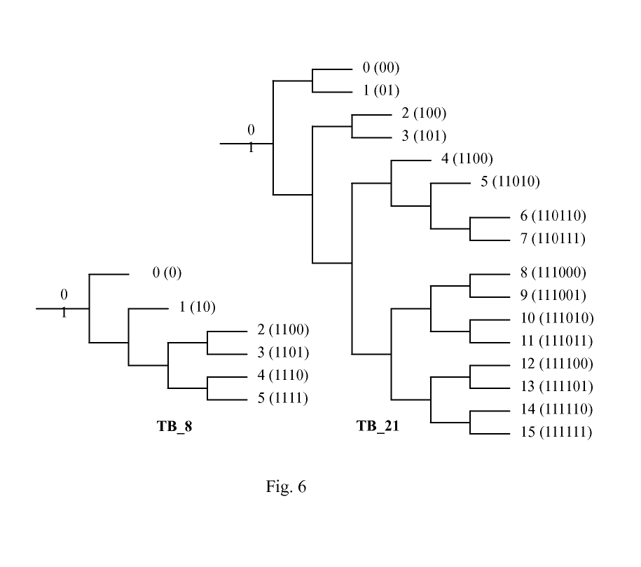

Class-B frequency bands are coded with one of the 22 class-B coding tables, and the same frequency band uses the same coding table. FIG. 6 gives the information of coding tables TB_{—}8 and TB_{—}21. Table 1 lists the maximum value of each coding tables, in which the symbol TB_Idx represents the index of coding tables, TB_{—}0, TB_{—}1, TB_{—}2, . . . , TB_{—}20, TB_{—}21 respectively, and the symbol MaxLvl represents the maximum value of the corresponding coding table. The maximum value in frequency bands determines which coding table to use for coding. For example, if the maximum absolute quantized value in a certain frequency band is 7, TB_{—}12 or TB_{—}13 may be chosen depending on using which to make the less coded bits. If the maximum absolute quantized value is 10, TB_{—}18 or TB_{—}19 may be chosen. If it is 12, directly use TB_{—}20. If it is 14, choose TB_{—}21. In addition, if the maximum absolute quantized value is above 15, TB_{—}21 is used. When the frequency band with the maximum value above 15 is to be coded, the table (TB_{—}21) is directly used for the frequency points with the value below 15. For the frequency sub-bands with the value above or equal to 15, 15 is first coded, then the difference between the value and 15 is coded with fixed length. The length of fixed code is the number of bits to completely represent the difference.

TABLE 1

| | TB_Idx | | | | | | | | | | |
|---|---|---|---|---|---|---|---|---|---|---|---|
| | 0 | 1 | 2 | 3 | 4 | 5 | 6 | 7 | 8 | 9 | 10 |
| MaxLvl | 2 | 2 | 2 | 8 | 3 | 3 | 4 | 4 | 5 | 5 | 6 |
| | TB_Idx | | | | | | | | | | |
| | 11 | 12 | 13 | 14 | 15 | 16 | 17 | 18 | 19 | 20 | 21 |
| MaxLvl | 6 | 7 | 7 | 8 | 8 | 9 | 9 | 11 | 11 | 13 | 15 |

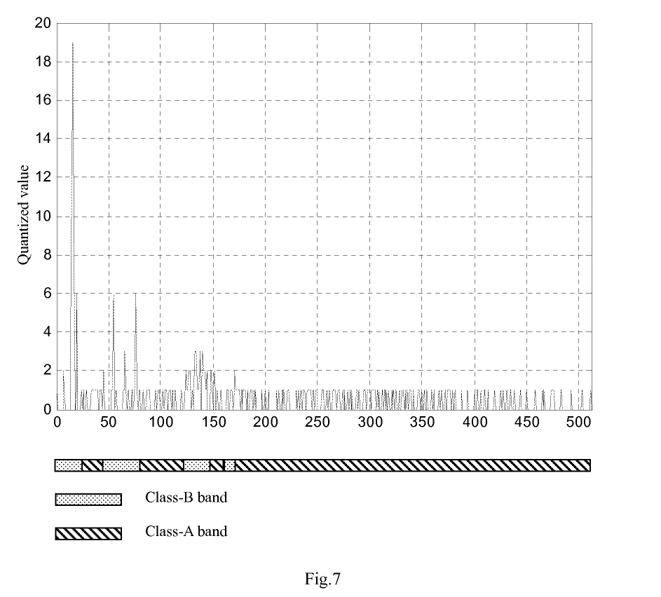

FIG. 7 gives an example of frequency band group partition.

Module 203 aforementioned computes the index to the coding table which leads to the lowest coded bit count, based on the result of frequency band partition (frequency band group information) and the relevant quantized value of spectrum. The index (each class-A and class-B frequency band has a corresponding coding table index) is coded into bit-stream. Coding of class-A and class-B is independent on each other; hence, the index computation is carried out independently.

Module 204 aforementioned codes the quantized spectrum based on the coding table of frequency bands and produce coded bit-stream. In general, the number of bits produced by this Module accounts for the largest proportion in the total bit-stream.

Besides, the complete coded bit-stream also contains some general auxiliary information, such as the sampling rate, the channel number and the bit-rate of coded bit-stream etc.

Finally, all the coded bits are formatted and generate the unique decodable bit-stream.

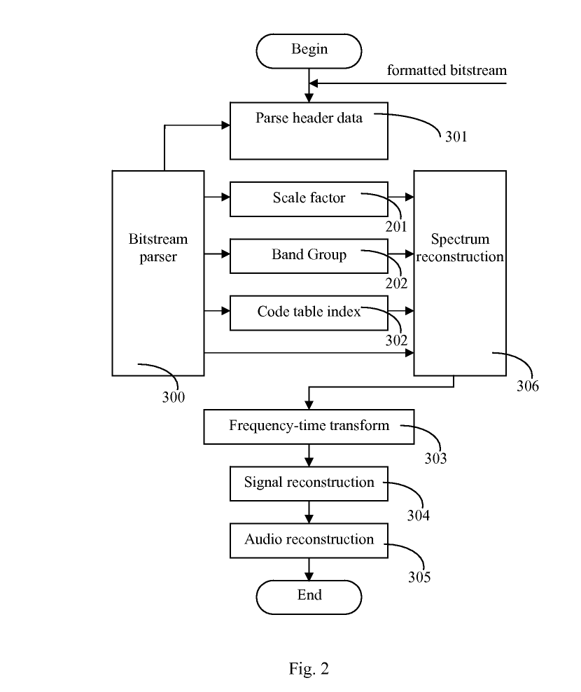

FIG. 2 is the block diagram of the decoder. It parses the formatted bit-stream in Module 300, applies decoding, inverse quantization and spectrum reconstruction of each frame in Module 306, makes the frequency-time transform in Module 303, reconstructs the time-domain signals in Module 304 and reconstructs channel signals in Module 305.

First, parse header data in Module 301 to retrieve the general decoder information, such as the sampling rate, the audio channel number and the bit-rate of coded bit-stream etc.

Second, decode the compressed data of each frame. The decoding process includes the decoding of the following information: 1) the scale factor of each Bark band in Module 201, 2) the frequency band group information in Module 202, 3) the coding table for each frequency band group (class-A and class-B) and 4) frequency sub-bands. Scale factors for each frequency sub-band is obtained based on the scale factor in Bark frequency bands. Coding table information for each sub-band is gained from the frequency band group information in Module 202 and coding table information for frequency bands in Module 302. Quantized spectrum data are decoded according to the frequency sub-band data and the relevant coding tables. Utilizing the quantized spectrum and the corresponding scale factor, the final un-quantized frequency spectrum is obtained by the inverse-scaling procedure.

Two embodiments below are given to explain the class-A frequency band decoding as illustrated in FIG. 5:

1) Suppose the coding table is TA_{—}3, and the bit-stream is 10101 . . . First, the codeword is obtained by table matching: 1010, the corresponding code value is 4, and covert 4 into 4-bit binary representation with reversed order: 0010. Next, extract the sign bit 1 from the bit-stream (‘1’ indicates negative), and the value of the 4 frequency sub-bands is 0, 0, −1, 0 respectively.

2) Suppose the coding table is TA_{—}2, and the bit-stream is 0 . . . First, the codeword is obtained by table matching: 0, the corresponding code value is 0, and converts 0 into 3-bit binary representation with reverse order: 000. Next, no sign bits present due to all 0. Consequently the value of the 3 frequency sub-bands is 0, 0, 0 respectively.

Two embodiments below are given to explain the class-B frequency band decoding as illustrated in FIG. 6:

1) Suppose the coding table is TB_{—}8, and the bit-stream is 11000 . . . First, the codeword is obtained by table matching: 1100, the corresponding code value is 2. Next, extract the sign bit 0 (‘0’ indicates positive) from the bit-stream, and the value of the corresponding frequency sub-band is +2.

2) Suppose the coding table is TB_{—}21, the fixed coding length is 3 and the bit-stream is 1111110111 . . . First, the codeword is obtained by table matching: 111111, the corresponding code value is 15 which indicates there are remaining bits with 15 to quantized frequency spectrum of the frequency sub-band; then read the subsequent 3 bits: 0 1 1, so the absolute value of frequency spectrum is 15+3=18. Last, extract the sign bit 1 (‘1’ indicates negative), thus, the value of the corresponding frequency sub-band is −18.

Finally, audio signals are reconstructed by applying frequency-to-time transform to inverse-scaled spectrum. The reconstructed audio signals, together with the sampling rate and the auxiliary channel information are used to reconstruct one audio frame of each channel. Repeat the decoding and reconstruction procedure, until all bit-stream data are decoded and the decoding process are concluded.

What is claimed is:

1. A method of implementation of audio codec, comprising:
At encoder side:
Step 1, apply time-to-frequency transform to audio signals, obtaining un-quantized spectrum data;
Step 2, based on un-quantized spectrum data and target bit count, calculate corresponding information of optimal scale factor, frequency band group, code table index and quantized spectrum by iteration;
Step 3, calculate and format bit-stream;
Step 4, output formatted bit-stream.
At the decoder side:
Parse the formatted bit-stream, apply decoding and inverse quantization to spectrum of each frame, reconstruct temporal audio data by frequency-to-time transform, and reconstruct time-domain signals of each channel.

2. The method as described in claim 1, wherein said step 2 further comprises:
Calculate total coded bit count based on the quantized spectrum data;
Compare it with expected bit count. If it can not meet expectation, adjust scale factor and change corresponding scale factors, consequently, quantized spectrum data are changed and information of frequency band group and relevant coding tables are adjusted accordingly; Recalculate total coded bit count and iterate until it is converge to the expected bit count, and
Obtain the formatted bit-stream.

3. The method as described in claim 1 or 2, wherein said scale factor is coded by way of using offset and differential coding.

4. The method as described in claim 1, wherein said frequency band group contains 1 frequency band group at least, and up to 4 frequency band group.

5. The method as described in claim 1 or 4, wherein said frequency band group is made up of a class-A frequency band and a successive class-B one.

6. The method as described in claim 5, in wherein said class-A frequency band, maximum absolute value of quantized data is 1, and value of quantized data can be one of the set {+1, 0, −1}.

7. The method as described in claim 5, in wherein said class-B frequency band, maximum absolute value of quantized data is larger than 1, but it may contain frequency band whose absolute value is 0 or 1.

8. The method as described in claim 5, wherein if maximum absolute value of all frequency bands is equal to 1, the maximum absolute value of class-B frequency band may be equal to 1.

9. The method as described in claim 5, wherein one of four class-A coding tables is employed to encode the said class-A frequency band, and same frequency band uses same coding table.

10. The method as described in claim 6, wherein one of four class-A coding tables is employed to encode class-A frequency bands, and the same frequency band uses same coding table.

11. The method as described in claim 6, wherein one of 22 class-B coding tables is employed to encoder the class-B frequency bands, and same frequency band uses same coding table.

12. The method as described in claim 7, wherein one of 22 class-B coding tables is employed to encoder the class-B frequency bands, and the same frequency band uses the same coding table.

13. The method as described in claim 8, wherein one of the 22 class-B coding tables is employed to encoder the said class-B frequency bands, and the same frequency band uses the same coding table.

14. The method as described in claim 1, wherein said scaling of spectrum data is implemented based on critical frequency band; all frequency sub-bands included in same critical frequency band uses same scale factor, and the scaling step-size is (\sqrt{2})^{-Scalefactor}.

15. The method as described in claim 9, wherein the said four class-A coding tables are TA_{—}0, TA_{—}1, TA_{—}2 and TA_{—}3 respectively. In the table TA_{—}0, the code is 0, 1, and the corresponding code value is 0, 1; in the table TA_{—}1, the code is 0, 10, 110, 111, and the corresponding code value is 0, 1, 2, 3; in the table TA_{—}2, the code is 0, 100, 101, 11100, 110, 11101, 11110, 11111, and the corresponding code value is 0, 1, 2, 3, 4, 5, 6,7; in the table TA_{—}3, the code is 0, 1000, 1001, 11000, 1010, 11001, 11010, 111011, 1011, 11011, 11100, 111100, 111010, 111101, 111110, 111111, and the corresponding code value is 0,1, 2, 3, 4, 5, 6, 7 , 8 ,9, 10, 11, 12, 13, 14, 15.

16. The method as described in claim 10, wherein the said four class-A coding tables are TA_{—}0, TA_{—}1, TA_{—}2 and TA_{—}3 respectively. In the table TA_{—}0, the code is 0, 1, and the corresponding code value is 0, 1; in the table TA_{—}1, the code is 0, 10, 110, 111, and the corresponding code value is 0, 1, 2, 3; in the table TA_{—}2, the code is 0, 100, 101, 11100, 110, 11101, 11110, 11111, and the corresponding code value is 0, 1, 2, 3, 4, 5, 6,7; in the table TA_{—}3, the code is, 0, 1000, 1001, 11000, 1010, 11001, 11010, 111011, 1011, 11011, 11100, 111100, 111010, 111101, 111110, 111111, and the corresponding code value is 0, 1, 2, 3, 4, 5, 6, 7, 8, 9, 10, 11, 12, 13, 14, 15.

17. The method as described in claim 11, wherein said 22 class-B coding tables are TB_{—}0, TB_{—}1, TB_{—}2, . . . , TB_{—}20, TB_{—}21, and the maximum value of the corresponding coding table is respectively 2, 2, 2, 8, 3, 3, 4, 4, 5, 5, 6, 6, 7, 7, 8, 8, 9, 9, 11, 11, 13, 15; in the table TB_{—}8, the code is 0, 10, 1100, 1101, 1110, 1111, the corresponding code value is 0, 1, 2, 3, 4, 5; in the table TB_{—}21, the code is 00, 01, 100, 101, 1100, 11010, 110110, 110111, 111000, 111001, 111010, 111011, 111100, 111101, 111110, 111111, the corresponding code value is 0, 1, 2, 3, 4, 5, 6, 7, 8, 9, 10, 11, 12, 13, 14, 15.

18. The method as described in claim 12, wherein said 22 class-B coding tables are TB_{—}0, TB_{—}1, TB_{—}2, . . . , TB_{—}20, TB_{—}21, and the maximum value of the corresponding coding table is respectively 2, 2, 2, 8, 3, 3, 4, 4, 5, 5, 6, 6, 7, 7, 8, 8, 9, 9, 11, 11, 13, 15; in the table TB_{—}8, the code is 0, 10, 1100, 1101, 1110, 1111, the corresponding code value is 0, 1, 2, 3, 4, 5; in the table TB_{—}21, the code is 00, 01, 100, 101, 1100, 11010, 110110, 110111, 111000, 111001, 111010, 111011, 111100, 111101, 111110, 111111, the corresponding code value is 0, 1, 2, 3, 4, 5, 6, 7, 8, 9, 10, 11, 12, 13, 14, 15.

19. The method as described in claim 13, wherein said 22 class-B coding tables are TB_{—}0, TB_{—}1, TB_{—}2, . . . , TB_{—}20, TB_{—}21, and the maximum value of the corresponding coding table is respectively 2, 2, 2, 8, 3, 3, 4, 4, 5, 5, 6, 6, 7, 7, 8, 8, 9, 9, 11, 11, 13, 15; in the table TB_{—}8, the code is 0, 10, 1100, 1101, 1110, 1111, the corresponding code value is 0, 1, 2, 3, 4, 5; in the table TB_{—}21, the code is 00, 01, 100, 101, 1100, 11010, 110110, 110111, 111000, 111001, 111010, 111011, 111100, 111101, 111110, 111111, the corresponding code value is 0, 1, 2, 3, 4, 5, 6, 7, 8, 9, 10, 11, 12, 13, 14, 15.

20. The method as described in claim 14, wherein said bandwidth distribution of critical frequency bands is: for the 32 KHz sampling rate condition, the number of critical frequency bands is 20, bandwidth of each critical frequency band is 6, 6, 6, 6, 6, 6, 9, 13, 17, 21, 25, 28, 32, 36, 40, 43, 47, 51, 55, 59 bins respectively, and the total bandwidth is 512 bins; For the 44.1 KHz sampling rate condition, the number of critical frequency bands is 21, the bandwidth of each critical frequency band is 4, 4, 4, 4, 4, 6, 8, 11, 13, 16, 18, 21, 24, 26, 29, 31, 34, 36, 39, 41, 44 bins respectively, and the total bandwidth is 417 bins; for the 48 KHz sampling rate condition, the number of critical frequency bands is 21, the bandwidth of each critical frequency band is 4, 4, 4, 4, 5, 7, 9, 11, 13, 15, 17, 20, 22, 24, 26, 28, 30, 32, 34, 36, 39 bins, and the total bandwidth is 384 bins.
